(19) United States
(12) Patent Application Publication
(10) Pub. No.: US 2011/0077904 A1
(43) Pub. Date: Mar. 31, 2011

(54) MOTION RECOGNITION SYSTEM USING FOOTWEAR FOR MOTION RECOGNITION

(75) Inventors: Ho Youl JUNG, Daejeon (KR); Min Ho KIM, Daejeon (KR); Sa Kwang SONG, Daejeon (KR); Jae Won JANG, Daejeon (KR); Soo Jun PARK, Seoul (KR); Seon Hee PARK, Daejeon (KR)

(73) Assignee: Electronics and Telecommunications Research Institute, Daejeon (KR)

(21) Appl. No.: 12/853,855

(22) Filed: Aug. 10, 2010

(30) Foreign Application Priority Data
Sep. 29, 2009 (KR) 10-2009-0092483

(51) Int. Cl. G06F 15/00

(52) U.S. Cl. 702/152

(57) ABSTRACT

There is provided a motion recognition system using footwear for motion recognition. The motion recognition system includes footwear for motion recognition and an information processing terminal. The footwear for motion recognition includes a pressure sensor, a height sensor and a three-axis acceleration sensor, measures variations in foot pressure, height and acceleration according to a user's motion, preprocesses signals measured by the sensors, and transmits the preprocessed signals. The information processing terminal analyses the signals received from the footwear for motion recognition, obtains information regarding the user's center of gravity, position within three-dimensional space and feet movements, and provides application services based on the obtained information.

### CROSS-REFERENCE TO RELATED APPLICATIONS

This application claims the priority of Korean Patent Application No. 10-2009-0092483 filed on Sep. 29, 2009, in the Korean Intellectual Property Office, the disclosure of which is incorporated herein by reference.

### BACKGROUND OF THE INVENTION

1. Field of the Invention

The present invention relates to a motion recognition system using footwear for motion recognition, and more particularly, to technology in which a user's center of gravity, position within three-dimensional space and feet movements are detected while the user is wearing footwear including a pressure sensor, a height sensor and a three-axis acceleration sensor for motion recognition, and a variety of services are provided to the user, such as a corrective posture service and a position recognition service for determining a user's position within an interior space, using information detected by the sensors.

2. Description of the Related Art

Conventionally, there has been proposed a system of detecting a user's feet movements while the user is wearing footwear having a built-in acceleration sensor or gyro-sensor and providing a variety of services using information gathered thereby.

However, the conventional system has a limitation in that it is only capable of detecting the user's feet movements on a single plane, and accordingly, services to be provided to the user, based on the detected information, have also been limited.

### SUMMARY OF THE INVENTION

An aspect of the present invention provides a motion recognition system using footwear including a pressure sensor, a height sensor and a three-axis acceleration sensor for motion recognition, which is capable of sensing a user's center of gravity, position within three-dimensional space, and feet movements while the user is wearing the footwear, thereby providing the user with a variety of services, such as a corrective posture service and a position recognition service for determining a user's position within an interior space, using information detected by the sensors.

According to an aspect of the present invention, there is provided a motion recognition system including: footwear for motion recognition including a pressure sensor, a height sensor and a three-axis acceleration sensor, measuring variations in foot pressure, height and acceleration according to a user's motion, preprocessing signals measured by the sensors, and transmitting the preprocessed signals; and an information processing terminal analyzing the signals received from the footwear for motion recognition, obtaining information regarding the user's center of gravity, position within three-dimensional space and feet movements, and providing application services based on the obtained information.

The footwear for motion recognition may further include a gyro-sensor for measuring angular velocity.

The footwear for motion recognition may further include a wireless communication module transmitting the preprocessed signals to the information processing terminal; and a control module preprocessing the signals measured by the pressure sensor, the height sensor and the three-axis acceleration sensor and controlling the wireless communication module to transmit the preprocessed signals to the information processing terminal.

The footwear for motion recognition may further include a built-in battery for driving each element included in the footwear for motion recognition.

The information processing terminal may include a wireless communication module receiving signals transmitted by the footwear for motion recognition; and a sensor signal analysis module calculating the user's center of gravity based on a foot pressure value measured by the pressure sensor among the signals received from the wireless communication module, calculating the user's position within three-dimensional space based on a height value and an acceleration value respectively measured by the height sensor and the three-axis acceleration sensor among the signals received from the wireless communication module, and obtaining information regarding the user's feet movements based on the user's position within the three-dimensional space calculated at a predetermined time interval.

The sensor signal analysis module may provide a corrective posture service or a position recognition service by using the user's center of gravity, position within three-dimensional space and feet movements.

In an exemplary embodiment, the information processing terminal may further include a database storing information regarding a correct center of gravity and position within three-dimensional space appropriate for each posture of an activity to be trained; and a display module, wherein the sensor signal analysis module may compare the calculated user's center of gravity and position with the information stored in the database and transmit a comparison result to the display module, so that the comparison result may be displayed by the display module.

In another exemplary embodiment, the information processing terminal may further include a database storing three-dimensional space information regarding a space in which the user is positioned; and a display module, wherein the sensor signal analysis module may represent the calculated user's position over the three-dimensional space information stored in the database to be combined information and transmit the combined information to the display module, so that the combined information may be displayed by the display module.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a view illustrating the configuration of a motion recognition system using footwear for motion recognition according to an exemplary embodiment of the present invention;

FIG. 2 is a view illustrating the detailed configuration of the footwear for motion recognition depicted in FIG. 1; and

FIG. 3 is a view illustrating the detailed configuration of the information processing terminal depicted in FIG. 1.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. Moreover, detailed descriptions related to well-known functions or configurations will be ruled out in order not to unnecessarily obscure the subject matter of the present invention. Throughout the drawings, the same reference numerals will be used to designate the same or like elements.

In addition, when one element is referred to as being “connected” to another element, it should be understood that the former can be “directly connected” to the latter, or “indirectly connected” to the latter via an intervening element. Furthermore, unless explicitly described to the contrary, the word “include” and variations such as “includes” or “including,” will be understood to imply the inclusion of stated elements but not the exclusion of any other elements.

In addition, the term “module” is defined as a single unit having a particular function or operation, which may be realized as hardware or software, or a combination of hardware and software.

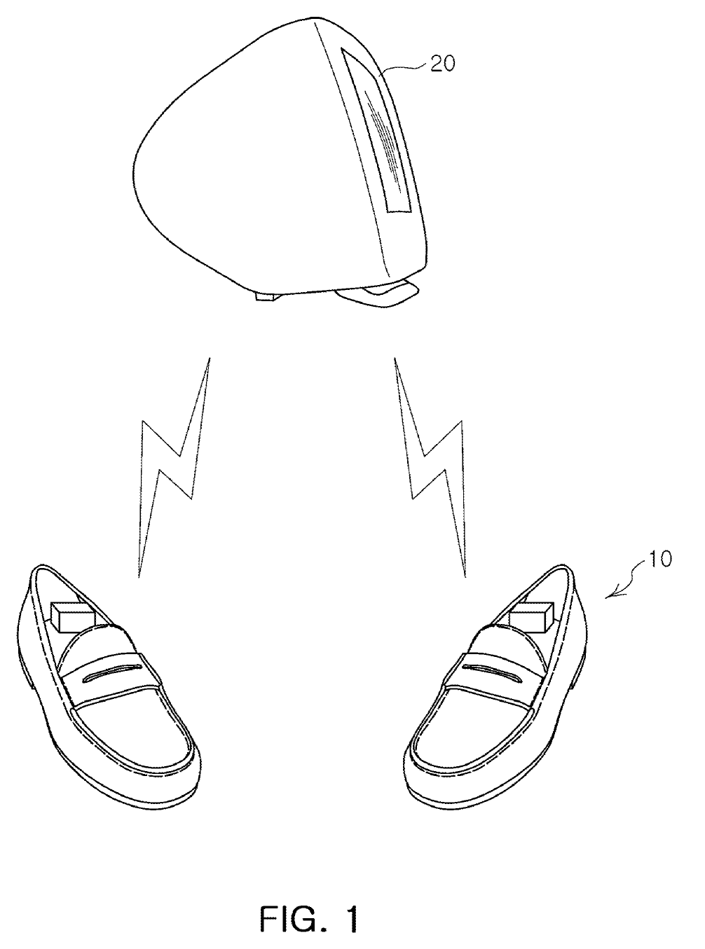

FIG. 1 is a view illustrating the configuration of a motion recognition system using footwear for motion recognition according to an exemplary embodiment of the present invention.

A motion recognition system according to this embodiment includes footwear 10 for motion recognition and an information processing terminal 20.

The footwear 10 includes a pressure sensor, a height sensor, and a three-axis acceleration sensor mounted therein, preprocesses signals obtained by these sensors, and transmits the preprocessed signals to the information processing terminal 20.

The information processing terminal 20 analyzes the signals received from the footwear 10 for motion recognition and obtains information regarding a user's center of gravity, position within three-dimensional space and feet movements while the user is wearing the footwear. Also, the information processing terminal 20 provides the user with a variety of services, such as a corrective posture service and a position recognition service for determining a user's position within an interior space, using the obtained information.

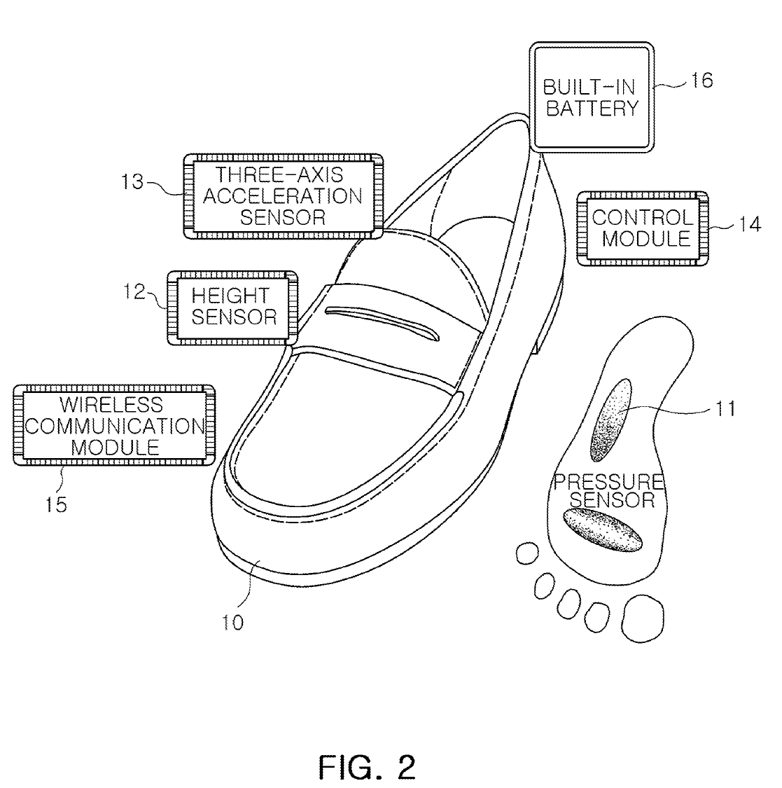

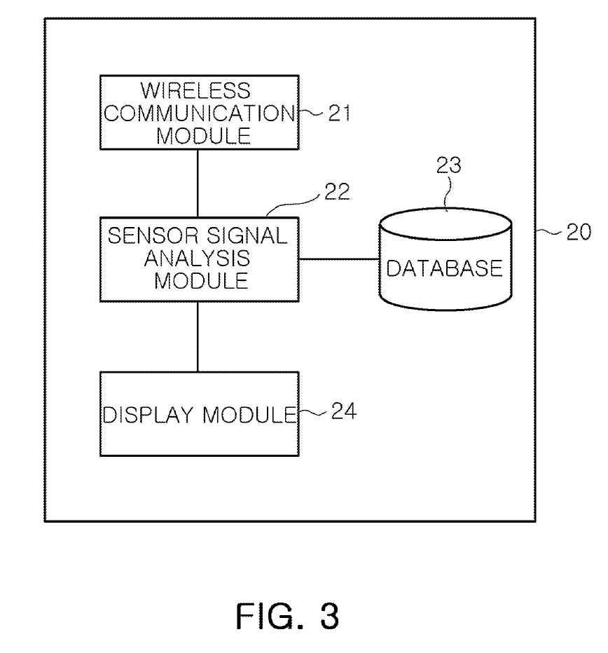

Hereinafter, the configuration and function of the footwear for motion recognition and the information processing terminal will be described in more detail with reference to FIGS. 2 and 3.

FIG. 2 is a view illustrating the detailed configuration of the footwear for motion recognition depicted in FIG. 1.

As shown in FIG. 2, the footwear 10 for motion recognition includes a pressure sensor 11, a height sensor 12, a three-axis acceleration sensor 13, a control module 14, a wireless communication module 15, and a built-in battery 16.

The pressure sensor 11 serves to measure a foot pressure of the user. The pressure sensor 11 may include a force sensing resistor (FSR) sensor or a piezoelectric sensor. Furthermore, one or more pressure sensors 11 may be disposed across the entire pad of the footwear 10 such that the entirety of the user's foot is covered.

The height sensor 12 serves to measure variations in height using the user's detected feet movements or variations in the user's position.

The three-axis acceleration sensor 13 serves to measure the acceleration of the user's feet.

Meanwhile, although not shown in FIG. 2, the three-axis acceleration sensor 13 may be replaced with a gyro-sensor so as to measure angular velocity. Also, both the three-axis acceleration sensor and the gyro-sensor may be used simultaneously to thereby detect the user's feet position with greater precision.

The control module 14 controls the operation of each of the elements included in the footwear 10 for motion recognition. Particularly, the control module 14 preprocesses the signals detected by the pressure sensor 11, the height sensor 12 and the three-axis acceleration sensor 13, and controls the wireless communication module 15 to transmit the preprocessed signals to the information processing terminal 20. The control module 14 may include a micro controller unit (MCU).

The wireless communication module 15 serves to transmit the signals preprocessed by the control module 14 to the information processing terminal 20, which may be implemented by wireless communication technology such as ZigBee or Bluetooth.

The built-in battery 16 supplies power for driving each of the elements included in the footwear 10.

FIG. 3 is a view illustrating the detailed configuration of the information processing terminal depicted in FIG. 1.

The information processing terminal 20 analyzes the signals received from the footwear 10 for motion recognition and obtains information regarding the user's center of gravity, position within three-dimensional space, and feet movements while the user is wearing the footwear 10. Also, the information processing terminal 20 provides the user with a variety of services, such as a corrective posture service and a position recognition service for determining a user's position within an interior space, using the obtained information. The information processing terminal 20 includes a wireless communication module 21, a sensor signal analysis module 22, a database 23, and a display module 24.

The wireless communication module 21 serves to receive data from the footwear 10 for motion recognition, which may be implemented by the same wireless communication technology as that of the wireless communication module 15 mounted in the footwear 10, such as ZigBee or Bluetooth.

The sensor signal analysis module 22 obtains information regarding the user's center of gravity, position within three-dimensional space and feet movements by using the signals received from the footwear 10 for motion recognition through the wireless communication module 21.

Specifically, the sensor signal analysis module 22 calculates the center of gravity of the user's body based on a foot pressure value measured by the pressure sensor 11 and calculates a position of the user in three-dimensional space based on a height value and an acceleration value measured by the height sensor 12 and the three-axis acceleration sensor 13. Also, the sensor signal analysis module 22 may provide information regarding the movements of the user's feet based on the user's position within three-dimensional space calculated at a predetermined time interval.

Also, the sensor signal analysis module 22 may provide a variety of services, such as a corrective posture service or a position recognition service, using the obtained information regarding the user's center of gravity, position within three-dimensional space, and feet movements.

The database 23 stores the information obtained by the sensor signal analysis module 22 as well as data required in order for the sensor signal analysis module 22 to provide a variety of services by using the obtained information. Specifically, the database 23 stores the information, obtained by the sensor signal analysis module 22, regarding the user's center of gravity, position within three-dimensional space and feet movements. Further, as described below, the database 23 stores information regarding a correct center of gravity, position within three-dimensional space, and the like, appropriate for each posture of an activity in which the user will be trained, according to types of services to be provided.

The display module 24 displays the information obtained by the sensor signal analysis module 22 or the information regarding the services to be provided using the obtained information.

As described above, the information processing terminal 20 may provide the user with a variety of services, such as the corrective posture service and the position recognition service, using the information obtained by the sensor signal analysis module 22, i.e., the user's center of gravity, position within three-dimensional space and feet movements.

For example, in the case of correct posture training for an activity in which the user will be trained through the use of the information processing terminal 20, information regarding a correct center of gravity and position within three-dimensional space appropriate for each posture of the activity is previously stored in the database 23. The sensor signal analysis module 22 compares the information stored in the database 23 with information regarding the user's center of gravity and position within three-dimensional space calculated by using the signals received from the footwear 10 and transmits the comparison result to the display module 24. The display module 24 displays the comparison result to the user. Accordingly, during the posture correction of the user wearing the footwear 10, the user's postures may be continuously evaluated and the user may be trained in correct posture by using the evaluation result.

in a further example, in the case of providing the position recognition service by using the information processing terminal 20, information regarding three-dimensional space in which the user is positioned (hereinafter, referred to as “three-dimensional space information”), e.g., an architectural model of a building in which the user is positioned, is previously stored in the database 23. The sensor signal analysis module 22 represents information regarding the user's position within three-dimensional space, calculated by using the signals received from the footwear 10, over the three-dimensional space information stored in the database 23 and transmits the combined information to the display module 24, so that the combined information is displayed by the display module 24.

As set forth above, according to exemplary embodiments of the invention, footwear including a pressure sensor, a height sensor and a three-axis acceleration sensor for motion recognition allows for the detection of a user's center of gravity, position within three-dimensional space and feet movements.

In addition, an information processing terminal provides training in correct posture of activities such as dance, gymnastics or Taekwondo by using information regarding a user's center of gravity, position within three-dimensional space and feet movements.

Furthermore, a person who works in a hazardous environment, such as a fireman, may be provided with a position recognition service through the use of information regarding position within three-dimensional space obtained from the footwear for motion recognition.

While the present invention has been shown and described in connection with the exemplary embodiments, it will be apparent to those skilled in the art that modifications and variations can be made without departing from the spirit and scope of the invention as defined by the appended claims.

What is claimed is:

1. A motion recognition system comprising:
footwear for motion recognition including a pressure sensor, a height sensor and a three-axis acceleration sensor, measuring variations in foot pressure, height and acceleration according to a user's motion, preprocessing signals measured by the sensors, and transmitting the preprocessed signals; and
an information processing terminal analyzing the signals received from the footwear for motion recognition, obtaining information regarding the user's center of gravity, position within three-dimensional space and feet movements, and providing application services based on the obtained information.

2. The motion recognition system of claim 1, wherein the footwear for motion recognition further comprises a gyro-sensor for measuring angular velocity.

3. The motion recognition system of claim 1, wherein the footwear for motion recognition further comprises:
a wireless communication module transmitting the preprocessed signals to the information processing terminal; and
a control module preprocessing the signals measured by the pressure sensor, the height sensor and the three-axis acceleration sensor, and controlling the wireless communication module to transmit the preprocessed signals to the information processing terminal.

4. The motion recognition system of claim 1, wherein the footwear for motion recognition further comprises a built-in battery for driving each element included in the footwear for motion recognition.

5. The motion recognition system of claim wherein the information processing terminal comprises:
a wireless communication module receiving signals transmitted by the footwear for motion recognition; and
a sensor signal analysis module calculating the user's center of gravity based on a foot pressure value measured by the pressure sensor among the signals received from the wireless communication module, calculating the user's position within three-dimensional space based on a height value and an acceleration value respectively measured by the height sensor and the three-axis acceleration sensor among the signals received from the wireless communication module, and obtaining information regarding the user's feet movements based on the user's position within the three-dimensional space calculated at a predetermined time interval.

6. The motion recognition system of claim 5, wherein the sensor signal analysis module provides a corrective posture service or a position recognition service by using the user's center of gravity, position within three-dimensional space and feet movements.

7. The motion recognition system of claim 6, wherein the information processing terminal further comprises:
a database storing information regarding a correct center of gravity and position within three-dimensional space appropriate for each posture of an activity to be trained; and
a display module,
wherein the sensor signal analysis module compares the calculated user's center of gravity and position with the information stored in the database and transmits a comparison result to the display module, so that the comparison result is displayed by the display module.

8. The motion recognition system of claim 6, wherein the information processing terminal further comprises:
a database storing three-dimensional space information regarding a space in which the user is positioned; and
a display module,
wherein the sensor signal analysis module represents the calculated user's position over the three-dimensional space information stored in the database to be combined information and transmits the combined information to the display module, so that the combined information is displayed by the display module.
